(19) United States
(12) Patent Application Publication
(10) Pub. No.: US 2014/0197755 A1
(43) Pub. Date: Jul. 17, 2014

(54) AN ACOUSTIC CEILING FOR A CAPACITIVE POWER TRANSFER SYSTEM

(71) Applicants: Oscar Hendrikus Willemsen, Den Bosch (NL); Theodorus Johannes Petrus Van Den Biggelaar, Veldhoven (NL); Giovanni Cennini, Eindhoven (NL)

(72) Inventors: Oscar Hendrikus Willemsen, Den Bosch (NL); Theodorus Johannes Petrus Van Den Biggelaar, Veldhoven (NL); Giovanni Cennini, Eindhoven (NL)

(73) Assignee: KONINKLIJKE PHILIPS N.V., EINDHOVEN (NL)

(21) Appl. No.: 14/238,853

(22) PCT Filed: Aug. 2, 2012
(86) PCT No.: PCT/IB2012/053950

§ 371 Date: Feb. 14, 2014

Related U.S. Application Data
(60) Provisional application No. 61/649,498, filed on May 21, 2012.
(60) Provisional application No. 61/548,397, filed on Oct. 18, 2011.
(60) Provisional application No. 61/523,953, filed on Aug. 16, 2011.

(51) Int. Cl. H04B 5/00; H05B 33/08; H05B 37/02

(52) U.S. Cl. CPC H04B 5/0012; H05B 37/02; H05B 33/08
USPC 315/227 R; 307/109

(57) ABSTRACT

An acoustic ceiling tile (200) operating as a capacitive power transfer sys tem comprises a first layer (231) comprising a non-conductive material; at least a pair of receiver electrodes (220, 221) of the capacitive power transfer system configured on a first side of the first layer; a foam layer (240) having a side substantially covered with the first layer; and a load (210) connected to an inductor (212) and to the pair of receiver electrodes, wherein the load and the inductor are configured in a chamber formed between the first layer and the foam layer, wherein a power signal generated by a power driver is wirelessly transferred from a pair of transmitter electrodes to the pair of receiver electrodes (220, 221)to power the load when a frequency of the power signal substantially matches a series-resonance frequency of the inductor and a capacitive impedance created between the pair of receiver electrodes and the pair of transmitter electrodes.

This application claims the benefit of U.S. provisional patent application No. 61/523,953 filed Aug. 16, 2011 and U.S. provisional application No. 61/548,397 filed Oct. 18, 2011 and U.S. provisional application No. 61/649,498 filed May 21, 2012.

The invention generally relates to capacitive power transfer and, more particularly, to the use of a conductive layer over surfaces for power distribution using capacitive power transfer.

A wireless power transfer refers to supplying electrical power without any wires or contacts, whereby the powering of electronic devices is performed through a wireless medium. One popular application for contactless powering is for charging portable electronic devices, e.g., mobile phones, laptop computers, and the like.

One implementation of wireless power transfers is by an inductive powering system. In such a system, the electromagnetic inductance between a power source (transmitter) and the device (receiver) allows for contactless power transfers. Both the transmitter and receiver are fitted with electrical coils, and when brought into physical proximity, an electrical signal flows from the transmitter to the receiver by a generated magnetic field.

In inductive powering systems, the generated magnetic field is concentrated within the coils. As a result, the power transfer to the receiver pick-up field is very concentrated in space. This phenomenon creates hot-spots in the system which limits the efficiency of the system. To improve the efficiency of the power transfer, a high quality factor for each coil is needed. To this end, the coil should be characterized with an optimal ratio of an inductance to resistance, be composed of materials with low resistance, and be fabricated using a Litze-wire process to reduce skin-effect. Moreover, the coils should be designed to meet complicated geometries to avoid Eddy-currents. Therefore, expensive coils are required for efficient inductive powering systems. A design for a contactless power transfer system for large areas would necessitate many expensive coils, whereby for such applications an inductive powering system may not be feasible.

Capacitive coupling is another technique for transferring power wirelessly. This technique is predominantly utilized in data transfers and sensing applications. A car-radio antenna glued on the window with a pick-up element inside the car is an example of a capacitive coupling. The capacitive coupling technique is also utilized for contactless charging of electronic devices. For such applications, the charging unit (implementing the capacitive coupling) operates at frequencies outside the inherent resonance frequency of the device.

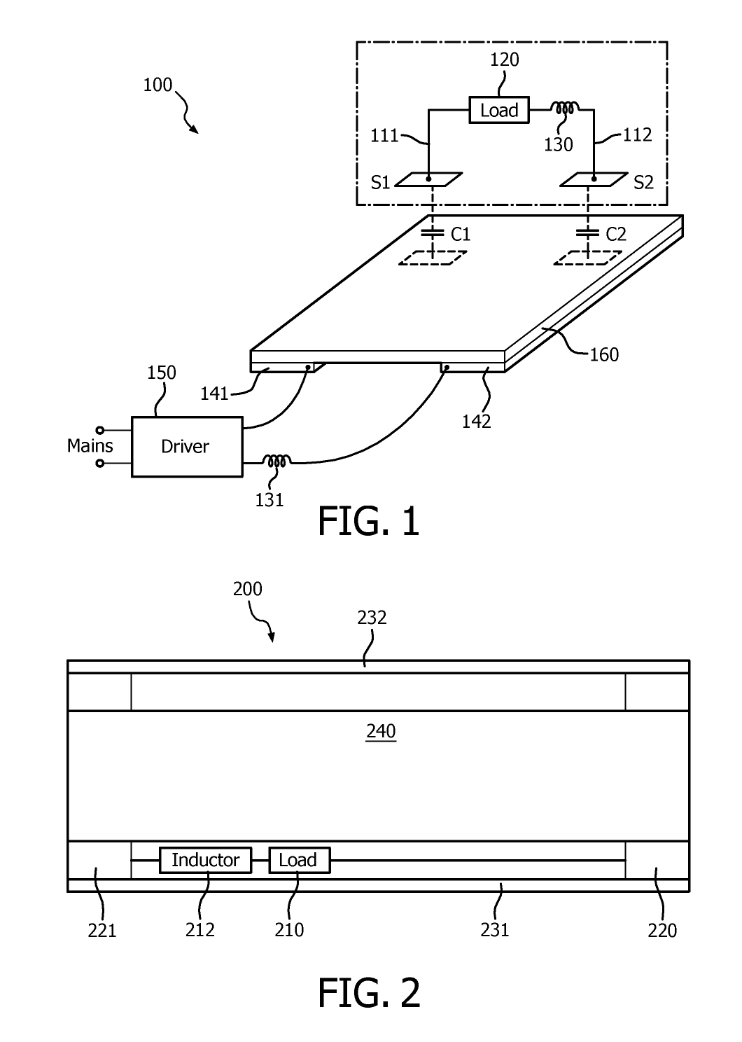

A capacitive power transfer system can also be utilized to transfer power over large areas, e.g., windows, having a flat structure and so on. An example is capacitive power transfer system 100 depicted in FIG. 1. As illustrated in FIG. 1, a typical arrangement of such a system includes a pair of receiver electrodes 111, 112 connected to a load 120 and an inductor 130. The system 100 also includes a pair of transmitter electrodes 141, 142 connected to a power driver 150, and an insulating layer 160.

The transmitter electrodes 141, 142 are coupled to one side of the insulating layer 160 and the receiver electrodes 111, 112 are coupled from the other side of the insulating layer 160. This arrangement forms capacitive impedance between the pair of transmitter electrodes 141, 142 and the receiver electrodes 111, 112. Therefore, a power signal generated by the power driver can be wirelessly transferred from the transmitter electrodes 141, 142 to the receiver electrodes 111, 112 to power the load 120 when a frequency of the power signal substantially matches a series-resonance frequency of the system. The series-resonance frequency of the system 100 is a function of the inductive value of the inductor 130 and/or inductor 131, as well as of the capacitive impedance between the pair of transmitter electrodes 141, 142 and the receiver electrodes 111, 112 (C1 and C2 in FIG. 1). The load may be, for example, a LED, a LED string, a lamp, and the like. As an example, the system 100 can be utilized to power lighting fixtures installed on ceilings.

To allow wireless power transfer over large ceiling surfaces there is a challenge of efficiently supplying the power at any arbitrary position along the surface without sacrificing the aesthetic characteristics of the ceiling. Another challenge is that in the system shown in FIG. 1, the insulation layer 160 is part of the infrastructure of the system, whereby a modification should be made to allow the operation of the capacitive powering system in ceiling surfaces in general, and in acoustic ceiling tiles in particular.

US Patent Publication No. 2004/0022058 discloses a lighting tile which includes embedded LEDs and control and sensing devices powered by a power source that is located in a support surface. The lighting tile includes metalized strips, which are operative to form a capacitive coupling with respective conductive elements disposed in an array on a supporting surface. The conductive elements on the supporting surface are connected to the power supply. However, such an arrangement cannot be utilized as an acoustic ceiling tile, because the conductive elements (e.g., transmitter electrodes) attach to and form an integrated part of the supporting surface.

An acoustic ceiling tile provides decorative and acoustical functions. Typically, such a tile includes a foam layer covered with decorative layers. The foam layer is typically a thick substrate of mineral wool with decorative layers (e.g., paint layers) that reduce acoustical reflection. The mineral wool layer is a barrier to acoustical noise that also provides the mechanical strength of the tile. Acoustic ceiling tiles may be mounted on a suspended ceiling system.

It may be desirable to provide acoustic ceiling tiles that can power a load (e.g., an illumination source) by means of a capacitive power transfer while maintaining the decorative and noise reduction characteristics of the tile.

Certain embodiments disclosed herein include an acoustic ceiling tile operating as a capacitive power transfer system. The acoustic ceiling tile comprises a first layer comprising a non-conductive material; at least a pair of receiver electrodes of the capacitive power transfer system configured on a first side of the first layer; a foam layer having a side substantially covered with the first layer; and a load connected to an inductor and to the pair of receiver electrodes, wherein the load and the inductor are configured in a chamber formed between the first layer and the foam layer, wherein a power signal generated by a power driver is wirelessly transferred from a pair of transmitter electrodes to the pair of receiver electrodes to power the load when a frequency of the power signal substantially matches a series-resonance frequency of the inductor and a capacitive impedance created between the pair of receiver electrodes and the pair of transmitter electrodes.

Certain embodiments disclosed herein also include an illuminating acoustic ceiling tile operating as a capacitive power transfer system. The illuminating acoustic ceiling tile comprises a first layer comprising a non-conductive material; a second layer comprising a non-conductive material; at least a pair of receiver electrodes of the capacitive power transfer system configured on a first side of the second layer; a foam layer substantially covered on opposite sides with the first layer and the second layer; and a lighting element connected to an inductor and to the pair of receiver electrodes, wherein the lighting element and the inductor are configured in a chamber formed between the foam layer and first layer, wherein a power signal generated by a power driver is wirelessly transferred from a pair of transmitter electrodes to the pair of receiver electrodes to power the lighting element when a frequency of the power signal substantially matches a series-resonance frequency of the inductor and a capacitive impedance created between the pair of receiver electrodes and the pair of transmitter electrodes.

Certain embodiments disclosed herein also include a method for manufacturing an acoustic ceiling tile operating as a capacitive power transfer system. The method comprises forming a first layer from a non-conductive material; forming a pair of receiver electrodes and a pair of transmitter electrodes on opposite sides of the first layer; forming a foam layer; forming a chamber between the foam layer and the first layer; configuring at least a load and an inductor within the chamber formed between the foam layer and the first layer; connecting the load in series to the inductor and to the pair of receiver electrodes; forming a second layer; and adhering the first and the second layers on opposite sides of the foam layer.

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 shows a capacitive power transfer system utilized for power transfer over large areas;

FIG. 2 shows a cross-section diagram of an acoustic ceiling tile operated as a capacitive power transfer system according to an embodiment;

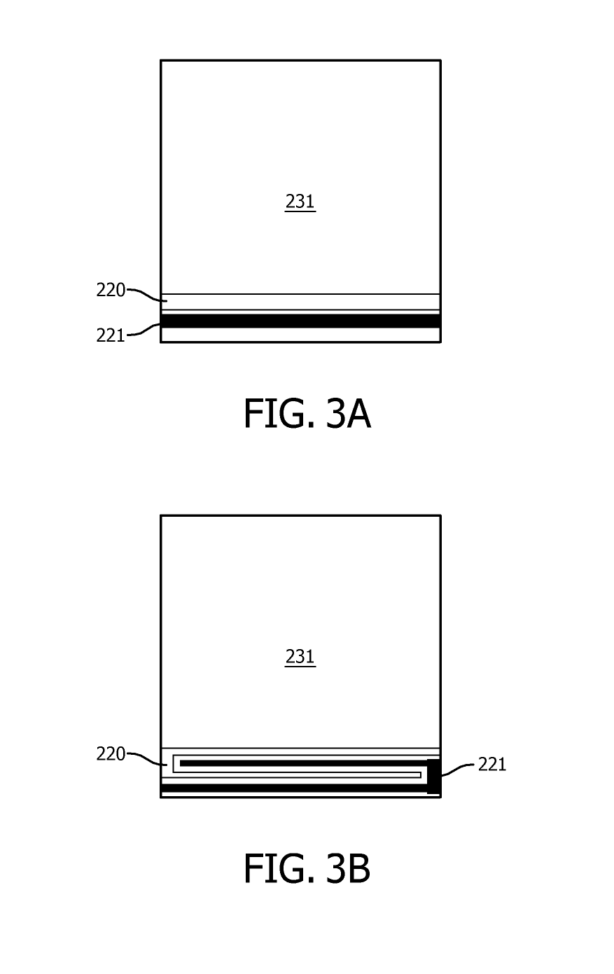

FIGS. 3A and 3B show possible arrangements of the receiver electrodes included in the acoustic ceiling tile;

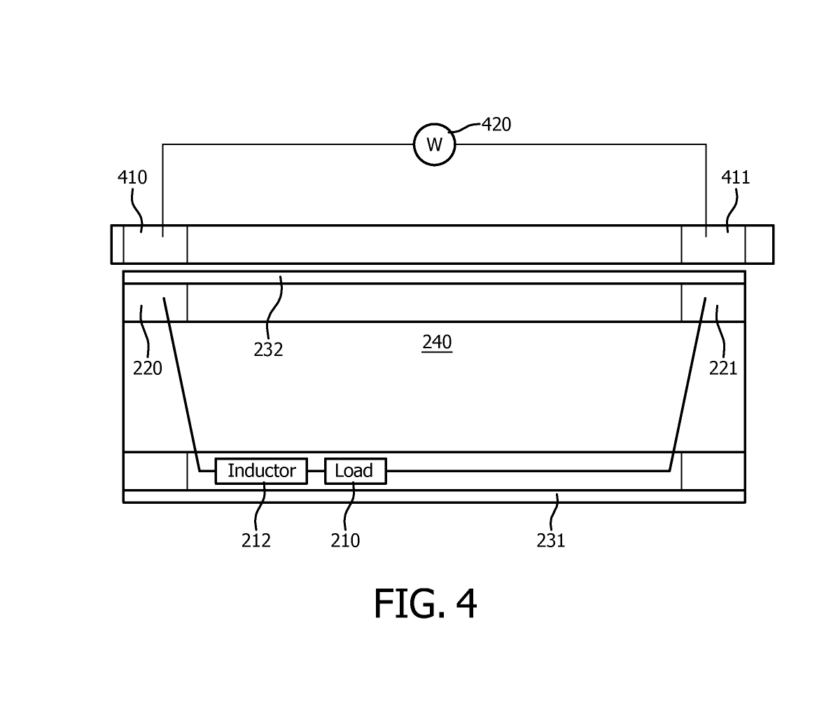

FIG. 4 shows a cross-section diagram of an acoustic ceiling tile operated as a capacitive power transfer system according to another embodiment;

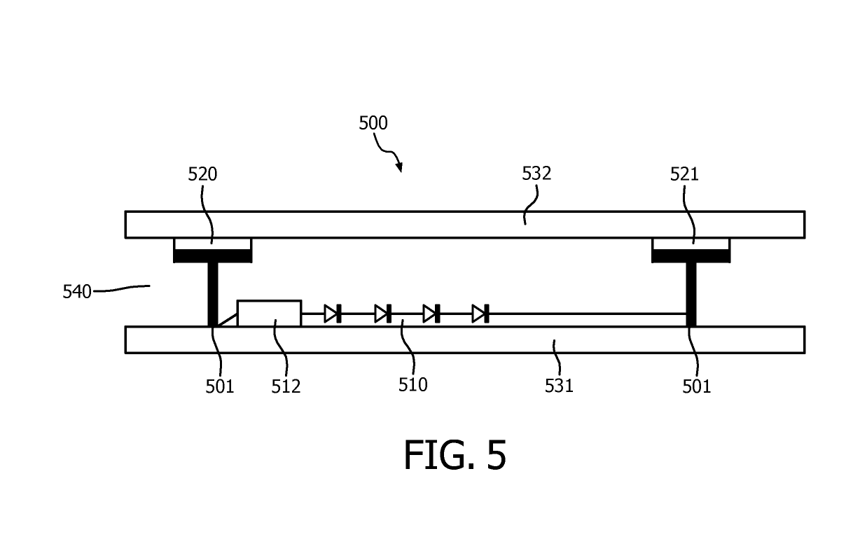

FIG. 5 is a cross-section diagram of an illuminating acoustic ceiling tile operated as a capacitive power transfer system according to an embodiment;

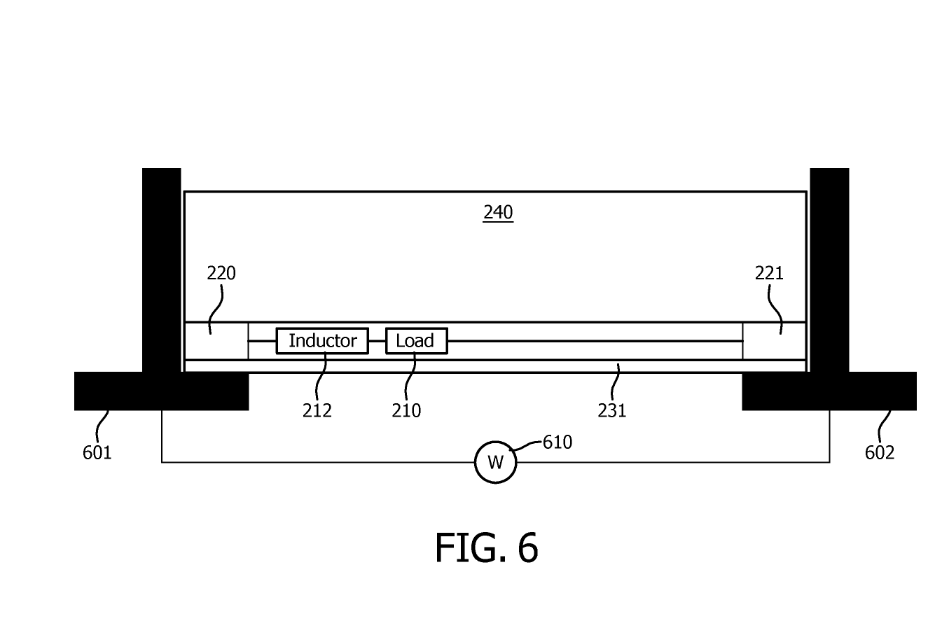

FIG. 6 is a diagram illustrating the connection of the acoustic ceiling tile to a power driver according to one embodiment;

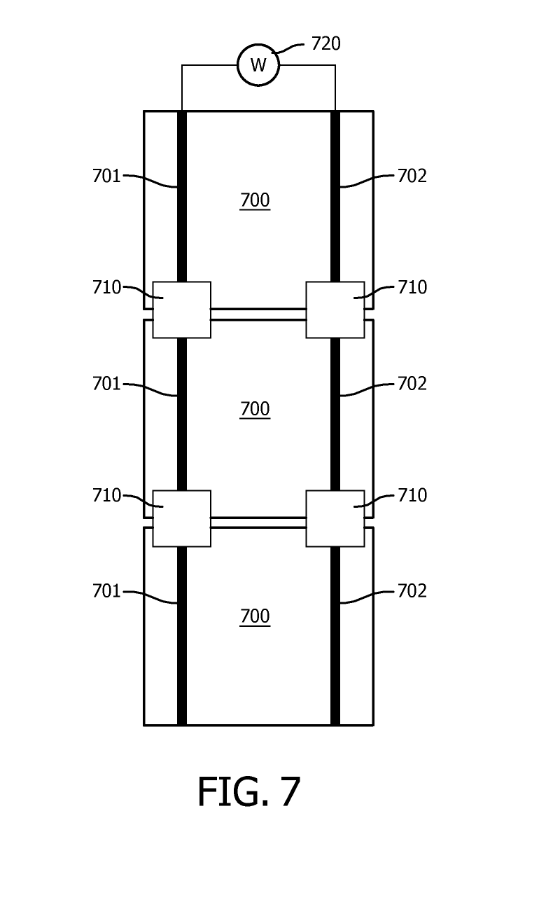

FIG. 7 is a diagram illustrating the connection of the acoustic ceiling tile to a power driver according to another embodiment; and

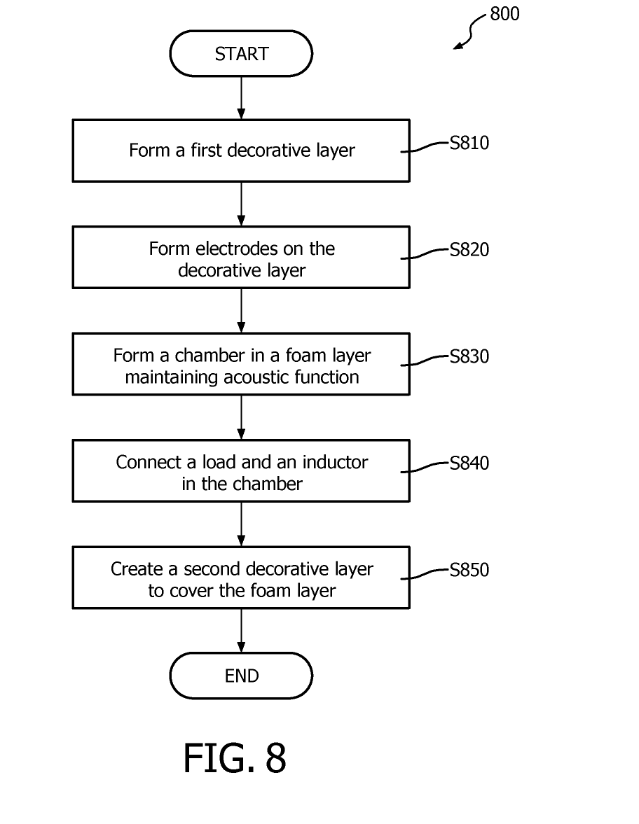

FIG. 8 is a flow chart describing a manufacturing method of the acoustic ceiling tile operable as a capacitive power transfer system.

It is important to note that the embodiments disclosed are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

FIG. 2 shows an exemplary and non-limiting cross-section diagram of an acoustic ceiling tile 200 designed to operate as a capacitive wireless power system according to one embodiment. The acoustic ceiling tile 200 is designed to operate as a capacitive wireless power system to wirelessly power a load 210. With this aim, the load 210 is connected in series to an inductor 212, which together are connected to at least a pair of receiver electrodes 220, 221. In an embodiment of the invention, illustrated in

FIG. 2, the load 210, inductor 212, and the receiver electrodes 220, 221 are assembled between one of the layers (e.g., 231) covering a foam layer 240 of the acoustic ceiling tile 200. The foam layer 240 may be made, for example, using substrate of mineral wool. The other layer is a layer 232.

The layers 231, 232 are typically made of non-conductive material, such as a fiber material coated by a paint layer. The thickness of the each of the layers is typically about tens of microns. The layer 231 is an insulating layer of the capacitive power transfer system. The layers 231, 232 may also be configured for appearance as a decorative or aesthetic portion of the ceiling tile 200, hence forming the decorative layers of the tile.

The receiver electrodes 220, 221 are made of conductive material including, for example, carbon, aluminum, indium tin oxide (ITO), organic material, such as Poly(3,4-ethylenedioxythiophene (PEDOT), copper, silver, or any conductive material. In a preferred embodiment, the receiver electrodes 220, 221 are made of, for example, conducting ink, conducting paint, and the like, where they can be painted, printed or added by using vapor deposition and sputtering techniques on the decorative layer 231.

In one embodiment, illustrated in FIG. 3A, the pair of receiver electrodes 220, 221 is formed as two stripes along the width or the length of the ceiling tile 200. The distance between the two stripes may be determined based on the application. According to another embodiment, the receiver electrodes 220, 221 may be formed using any shape (e.g., a rectangle, a circle, a square, or combinations thereof).

In yet another configuration, illustrated in FIG. 3B, the receiver electrodes 220, 221 are two stripes alternatingly placed one next to the other. The electrodes 220, 221 can be alternatingly attached to a positive electric potential or a negative electric potential. It should be noted that by placing the electrodes 220, 221 close to each other, the electric field is canceled at longer distances. This may be advantageous for compliance with EMF and EMC regulations.

In accordance with another embodiment illustrated in FIG. 4, the ceiling tile is constructed in such a way that the load 210 and the inductor 212 are connected between the foam layer 240 and one of the layers (e.g., layer 231), while the receiver electrodes 220, 221 are connected between the foam layer 240 and another of the layers (e.g., layer 232). A galvanic contact is made between the load 210, inductor 212, and the receiver electrodes 221, 222 as illustrated in FIG. 4.

To power the load 210 a pair of transmitter electrodes 410, 411 connected to a driver 420 are placed in proximity to the receiver electrodes 220, 221 in such a way that the transmitter electrodes 410, 411 overlap the receiver electrodes 220, 221. The electrodes 220, 221 and 410, 411 are separated by the layer 232 that acts as an insulating layer of the capacitive power transfer system. As a result, capacitive impedance is formed between the receiver and transmitter electrodes 220, 221 and 410, 411 respectively. This impedance together with the inductor 212 allows the capacitive power transfer system to resonate. In a certain configuration, an inductive element (not shown) may be connected to the driver 420.

To allow the ceiling tile 200 (either in the configuration illustrated in FIG. 2 or FIG. 4) to operate efficiently as a capacitive power transfer system, the power driver 420 outputs an AC power signal having a frequency substantially the same as the series-resonance frequency of a circuit consisting of a series of capacitors (equivalent to the capacitive impedance) and the inductor 212. The impedances of such capacitors and the inductor cancel each other out at the resonance frequency, resulting in a low-ohmic circuit. The load 210 may be connected on a PCB that may or may not include the inductor 212. In another configuration, the load 210 and inductor 212 may be connected on a wire grid.

The power driver 420 may be connected to the transmitter electrodes 410, 411 by means of a galvanic contact or a capacitive in-coupling. The load 210 may be, but is not limited to, a lighting element (e.g., a LED, a LED string, a lamp, etc.), an organic light emitting diode (OLED) surface, a projector, a LED display, loudspeakers, and the like.

The transmitter electrodes 410, 411 are made of conductive material which may be one the materials mentioned above. The transmitter electrodes 410, 411 may be painted as conductive paint, printed using conductive ink, adhered as conductive tapes, or formed using vapor deposition and sputtering techniques.

In an embodiment, the ceiling tile 200 is constructed to include a lighting element as the load 510 to form an illuminating tile 500 as illustrated in FIG. 5. The layer 531 is made of transparent or semi-transparent non-conductive material. Hence, in an example configuration when a lighting element 510 (e.g., the load) is wirelessly powered, light illuminates downwards from the ceiling to the floor.

Each of the receiver electrodes 520, 521 is connected to a pin-shaped connector 501. The pin-shaped connector 501 is pushed through the foam layer 540 and is held together by means of mechanical pressure. The pin-shaped connector 501 ends in a chamber that is created by cutting parts of the foam layer 540 to hold a lighting element 510, and an optional inductor 512. A layer 532 covers the other side of the foam layer 540.

The lighting element 510 may be, for example, a LED, a LED string, a lamp, an organic light emitting diode (OLED) surface, and the like. In certain configurations, in the chamber formed between the foam layer 540 and the layers 531, 532, a controller or electronic circuitry (both not shown in FIG. 5) may also be connected. The lighting element 510 and the inductor 512 can be connected on a PCB, a wire grid, and the like. The electronic circuitry may include (a) auto-tuning circuits configured to tune the circuit, such that the lighting element 510 is powered at the series-resonance frequency, (b) rectifying circuits to drive a load at a DC current, or (c) a controller to allow dimming the lighting element 510. The lighting element 510 may include configurations of LEDs in series, parallel, and/or anti-parallel.

In one embodiment, the illuminating ceiling tile 500 is designed to provide a luminous flux that is sufficient for providing general lighting in a room. The luminous flux of the light can range from 300-400 Lumen per tile of 60×60 cm, if the complete ceiling is covered. In another configuration, the luminous flux can range between 3000 and 4000 Lumen per tile if the tiles are positioned only at the positions of the current lighting system, i.e., only certain tiles in the ceiling are illuminating ceiling tiles.

It should be further appreciated that the acoustic ceiling tiles (e.g., tiles 200 and 500) designed according to various embodiments of the invention can be installed by placing the tiles on a suspension grid configured for holding the ceiling tiles. Therefore, the installation of the ceiling tiles disclosed herein is performed using current techniques known for installing ceiling tiles known to contractors or builders. The layers 531 and 532 may also be configured for appearance as a decorative or aesthetic portion of the ceiling tile 500, thereby serving as the decorative layers of the tile.

For example, illuminated ceiling tile 500 can be used to light a room, providing decorative and acoustic properties. The installation of such tiles requires, for example, placing the tiles on a suspension grid. On the other hand, installing lighting elements in a ceiling would require an electrician to drill into the ceiling to install the lighting fixtures and wire the fixtures to a power outlet.

FIG. 6 shows an exemplary and non-limiting cross-section diagram illustrating the connection of the acoustic ceiling tile to a power driver according to an embodiment of the invention. The ceiling tile is mounted on a suspension grid that is connected to a power driver 610. In the diagram shown in FIG. 6, the driver 610 is connected by means of a galvanic contact. However, such a connection may alternatively be made by means of a capacitive in-coupling.

The suspension grid is typically made of conductive material, e.g., iron, steel or aluminium. The outside of the suspension grid (i.e., the visible part when looking at the ceiling) may be painted with a non-conductive material or coated with a metal oxide. Rails 601, 602 of the suspension grid serve as the transmitter electrodes of the capacitive power transfer system. As the receiver electrodes 220, 221 face the inside of the suspension grid, an electric contact is established between the rails 601, 602 and electrodes 220, 221.

The driver 610 outputs an AC power signal having a frequency that substantially matches the series-resonance frequency of the capacitive impedance and the inductor 212. The impedances of such capacitors and the inductor cancel each other out at the resonance frequency, resulting in a low-ohmic circuit. The amplitude of the AC power signal is the amplitude required to power the load 210. It should be appreciated that the power can be supplied to the illuminating ceiling tile 500 in the same manner.

In accordance with another embodiment, illustrated in FIG. 7, the electric connection of an array of tiles 700 is achieved by means of conductive tapes 710. According to this embodiment, the transmitter electrodes 701, 702 are connected to the electrodes of its adjacent tiles by means of conductive tapes 710. The transmitter electrodes 701, 702 may be conductive paint, conductive ink, or conductive tapes. The conductive tapes 710 may be made of a metallic adhesive, such as a copper tape.

Only the transmitter electrodes 701, 702 of one of the tiles are connected to a power driver 720. Such a connection may be by means of a galvanic contact or a capacitive in-coupling. The power signal is transferred to receiver electrodes (not shown in FIG. 7) by means of capacitive coupling as described above. Each of tiles 700 is constructed as the acoustic ceiling tile 200 or 500. The receiver electrodes of the tile 700 can be formed as two stripes along the length of the tile 700 on the opposite side of the layer on which the transmitter electrodes (701,702) are formed.

The acoustic ceiling tiles operating as a capacitive power transfer system designed according to certain embodiments of the invention can be manufactured using a mass-manufacturing process. Specifically, the current mass-manufacturing process for acoustic tiles can be modified to allow manufacturing of the acoustic ceiling tiles 200 and/or illuminating tiles 500.

FIG. 8 shows a non-limiting and exemplary flow chart 800 illustrating a manufacturing method of tiles, such as the acoustic ceiling tiles configured for operating as a capacitive power transfer system according to one embodiment. At S810, a first layer is formed. The first layer, which can serve as a decorative layer, is made of a fiber material coated by a paint layer. In one embodiment the paint layer has a structure that is designed to reduce acoustic reflections. The thickness of the first layer is typically about tens of microns. The first layer serves as the insulating layer of the capacitive power transfer system.

At S820, a pair of conductive electrodes is placed on the top and bottom sides of the first layer. The electrodes may be painted as conductive paint, printed using conductive ink, adhered as conductive tape, or formed using vapor deposition and sputtering techniques.

At S830, a chamber is created by cutting parts of the foam layer (e.g., solid mineral wool material or other noise insulating material). The chamber is shaped in a way that the acoustic function of the tile is maintained. The chamber contains at least the load and the inductor of the capacitive power transfer system. In certain configurations, the chamber is also designed to contain electronic circuitry.

At S840, an indicator and a load (e.g., a lighting element) are connected to the electrodes acting as the receiver electrodes. In one embodiment, the connection is achieved using pin-shaped connectors and a soldering process. At S850, a second layer is formed to cover the other side of the foam layer to complete the assembly of the tile. The second layer may be made using the same material as the first layer. In one embodiment, the first and second layers of the manufactured tile may also be configured for appearance as a decorative or aesthetic portion of the ceiling tile, thereby serving as the decorative layers of the tile.

A person of ordinary skill in the art would readily realize that the descriptions provided herein are merely for illustration purposes and other embodiments are possible without departing from the scope of the invention. For example, while the description provided is with respect of an acoustic ceiling tile, the embodiments disclosed herein should not be viewed as limited to acoustic ceiling tiles. For example, furniture that includes fabric material (e.g., a couch), cubicle walls, and the like can be constructed as the acoustic ceiling tiles disclosed herein.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. An acoustic ceiling tile operating as a capacitive power transfer system, comprising:
a first layer comprising a non-conductive material;
at least a pair of receiver electrodes of the capacitive power transfer system configured on a first side of the first layer;
a foam layer having a side substantially covered with the first layer; and
a load connected to an inductor and to the pair of receiver electrodes, wherein the load and the inductor are configured in a chamber formed between the first layer and the foam layer, wherein a power signal generated by a power driver is wirelessly transferred from a pair of transmitter electrodes to the pair of receiver electrodes to power the load when a frequency of the power signal substantially matches a series-resonance frequency of the inductor and a capacitive impedance created between the pair of receiver electrodes and the pair of transmitter electrodes.

2. The acoustic ceiling tile of claim 1, wherein:
the at least a pair of transmitter electrodes of the capacitive power transfer system are configured on a second side of the first layer, wherein the first and second sides of the first layer are opposite to each other; and
a second layer is configured to substantially cover a side of the foam layer opposite a side covered by the first layer.

3. The acoustic ceiling tile of claim 1, wherein the first layer constitutes a dielectric for forming a capacitive impedance between the at least a pair of transmitter electrodes and the at least a pair of receiver electrodes.

4. The acoustic ceiling tile of claim 1, wherein each of the pair of receiver electrodes and the pair of transmitter electrodes comprise conductive material.

5. The acoustic ceiling tile of claim 4, wherein the conductive material comprises at least one of a conductive paint, a conductive ink, and a conductive tape.

6. The acoustic ceiling tile of claim 1, wherein the power driver is connected to a suspension grid configured to suspend the acoustic ceiling tile to form a ceiling.

7. The acoustic ceiling tile of claim 6, wherein the pair of transmitter electrodes are rails of a suspension grid configured to suspend the tile and transfer the power signal from the rails of the suspension grid to the receiver electrodes of tiles configured on the suspension grid.

8. The acoustic ceiling tile of claim 2, wherein transmitter electrodes of a plurality of acoustic ceiling tiles are electrically coupled together using a conductive tape

9. The acoustic ceiling tile of claim 2, wherein the transmitter electrodes and receiver electrodes are separated by the second layer,

10. An illuminating acoustic ceiling tile operating as a capacitive power transfer system, comprising:
a first layer comprising a non-conductive material;
a second layer comprising the non-conductive material;
at least a pair of receiver electrodes of the capacitive power transfer system configured on a first side of the second layer;
a foam layer substantially covered on opposite sides with the first layer and second layer; and
a lighting element connected to an inductor and to the pair of receiver electrodes, wherein the lighting element and the inductor are configured in a chamber formed between the foam layer and first layer, wherein a power signal generated by a power driver is wirelessly transferred from a pair of transmitter electrodes to the pair of receiver electrodes to power the lighting element when a frequency of the power signal substantially matches a series-resonance frequency of the inductor and a capacitive impedance created between the pair of receiver electrodes and the pair of transmitter electrodes.

11. The illuminating acoustic ceiling tile of claim 10, wherein:
the at least a pair of transmitter electrodes of the capacitive power transfer system are configured on a second side of the second layer, wherein the first and the second sides of the second layer are opposite to each other.

12. The illuminating acoustic ceiling tile of claim 11, wherein at least the second layer constitutes a dielectric for the capacitive impedance, wherein the non-conductive material of the second layer is any one of transparent or semi-transparent material.

13. The illuminating acoustic ceiling tile of claim 1, wherein the lighting element is any one of a LED, a LED string, a lamp, and an organic light emitting diode (OLED) surface and the foam configured for acoustic reduction.

14. A method for manufacturing of an acoustic ceiling tile operating as a capacitive power transfer system, comprising:
forming a first layer from a non-conductive material;
forming a pair of receiver electrodes and a pair of transmitter electrodes on opposite sides of the first layer;
forming a foam layer;
forming a chamber between the foam layer and the first layer;
configuring at least a load and an inductor within the chamber formed between the foam layer and the first layer;
connecting the load in series to the inductor and to the pair of receiver electrodes;
forming a second layer; and
adhering the first and the second layers on opposite sides of the foam layer.
